(19) United States
(12) Patent Application Publication
(10) Pub. No.: US 2007/0223537 A1
(43) Pub. Date: Sep. 27, 2007

(54) Method of and apparatus for determining relative time alignment

(75) Inventors: Martin Richard Crowle, Devon (GB); Timothy Michael Edmund Frost, Plymouth (GB)

Correspondence Address: ARENT FOX PLLC, 1050 CONNECTICUT AVENUE, N.W., SUITE 400, WASHINGTON, DC, 20036, US

(73) Assignee: Zarlink Semiconductor Limited

(21) Appl. No.: 11/723,751

(22) Filed: Mar. 21, 2007

Related U.S. Application Data
(60) Provisional application No. 60/783,852, filed on Mar. 21, 2006.

(30) Foreign Application Priority Data
Nov. 16, 2006 (GB) 0622840.7

(51) Int. Cl. H04J 3/06

(52) U.S. Cl. 370/503; 370/350

(57) ABSTRACT

An arrangement is provided for determining the relative time alignment between a first time base in a first interface and a second time base in a second interface. Packets of different sizes are sent in either or both directions and their propagation delays are determined in an alignment control section at the destination. The calculated propagation delays may then be used to improve the alignment of the “slave” time base.

### TECHNICAL FIELD

The present invention relates to a method of and a system for determining relative time alignment of first and second time bases separated by a packet network.

### BACKGROUND

It is a common requirement to distribute timing information via an asynchronous network, such as a packet network. For example, it is a common requirement for slave clocks at one or more destinations to be synchronised to a master clock at a source. In some applications, it is further required that the slave clocks are phase-locked with an absolute timing alignment. For example, in cellular telephone systems, the base stations for the individual cells are required to be phase-locked and time-aligned so as to avoid cell-to-cell interference.

FIG. 1 of the accompanying drawings illustrates a known arrangement for providing phase-locking and time-alignment across a packet network 1. A source 2 sends timing packets across the network 1 to a destination 3. The source 2 contains a master clock 4 in the form of a stable clock oscillator, which produces a reference frequency f_{ref} and from which is derived an alignment signal f_{align}. These signals are supplied to a timestamp insertion section 5, which applies a timestamp to packets sent to the network by the source 2 and received from the network. The alignment signal f_{align} typically has a frequency of 1 Hz, 500 Hz, 8 kHz, or any other frequency derived from the reference frequency f_{ref} by division by an integer. The alignment signal f_{align} is typically used to reset to zero a counter within the section 5 for providing the timestamp.

The source also comprises a packet formation section 6, which forms packets for transmission across the network 1 and which receives packets via the network 1. The packet formation section 6 forms timing packets which are sent at suitable intervals via the network 1 to the destination 3 for permitting phase-locking across the network. The timing packets may contain useful payload data or may contain dummy data. In a typical example of such an arrangement, the timing packets are transmitted at a rate of 100 per second and the interval between consecutive packets may be constant or may vary.

The destination 3 comprises a slave clock 7, which is required to be phase-locked and time-aligned to the master clock in the source 2. The clock 7 supplies a clock signal f which is required to be phase-locked to the reference frequency f_{ref} from the master clock 4, and an alignment signal fs_{align}, which is required to be time-aligned with the master alignment signal f_{align}. The signals from the clock 7 are supplied to another timestamp insertion section 8 for timestamping packets received from and sent to the network 1. A synchronising arrangement illustrated as a loop filter 10 controls and adjusts the slave clock 7 so as to achieve phase-locking and time-alignment.

The timestamp insertion section 8 receives packets for transmission across the network 1 from a packet formation section 10 and supplies packets from the network to the section 9. An alignment control section 11 receives information from the section 10 and controls the loop filter 9 so as to time-align the slave clock 7 to the master clock 4.

The timestamp insertion section 8 timestamps received and transmitted packets with a timestamp derived from the local slave clock 7. The timestamps in the timing packets received from the source 2 via the network 1 are used in the loop filter 9 to synchronise the slave clock signal fₛₗₐᵥₑ to the master clock signal f_{ref} by any suitable means and an example of an arrangement for providing such phase-locking is disclosed in EP 1455473.

In order to provide time-alignment between the master and slave clocks, at least some of the timing packets are used to derive a measure of the propagation delay across the packet network 1. Thus, the packet formation section 10 sends a packet for measuring propagation delay to the source 2 and this packet is stamped with a timestamp Td1 in the section 8 at the time of transmission. Initially, the relative time alignments of the clocks 4 and 7 are not known but it is assumed that the clocks are synchronised or nearly synchronised by the timing packets and the loop filter 9. When the packet is received at the source 2, it is timestamped with a local “source” time Ts1. The packet is supplied to the packet formation section 6, which generates a packet for sending to the destination 3, which may be one of the timing packets or may be a different packet. The “return” packet is timestamped with a source time Ts2 at the time of transmission to the network 1. When the packet is received at the destination 3, it is timestamped with the destination time Td2. The packet is then supplied via the section 10 to the alignment control section 11 for deriving the propagation delay across the packet network 1 between the source and the destination.

The alignment control section 11 has sufficient information in the packet to derive the two-way propagation delay in the network 1. In particular, the total round-trip delay measured at the destination is (Td2−Td1). The delay in the source 2 between receiving the packet and transmitting the return packet is given by (Ts2−Ts1). The total two-way propagation delay across the network 1 is given by the difference between these measurements (Td2−Td1)−(Ts2−Ts1). The alignment control section 11 makes the implicit assumption that the transmission paths in each direction through the packet network are essentially symmetrical so that the propagation delay in each direction is half of the total propagation delay, namely ((Td2−Td1)−(Ts2−Ts1))/2. Once the one-way propagation delay has been found in this way, the relative time alignment between the master clock 4 and the slave clock 7 can readily be determined and the slave clock 7 may be controlled so as to synchronise the slave alignment signal fs_{align} with the master alignment signal f_{align}.

This process is performed repeatedly for as long as the source 2 sends timing packets to the destination 3 for aligning the slave clock 7. Thus, the timing packets are used to maintain phase-locking between the clocks and the two-way packet transmission is repeated periodically so as to check and adjust the relative alignments of the clocks, for example to synchronise the slave clock 7 to the master clock 4. The slave alignment signal fs_{align} may also be used to reset a timing counter for performing timestamping in the section 8.

FIG. 1 illustrates an arrangement in which the measurement of relative timing alignment is initiated by sending the packet 12 from the source 3 to the destination 2. However, this process may be initiated by the source 2 by means, for example, of some or all of the timing packets. In this case, after the two-way round trip, a packet containing the four timestamps required for determining the packet network propagation delay will arrive at the source 2 rather than the destination 3. Since this information is required at the destination 3, a further packet, such as the next timing packet, may be sent to the destination 3 containing the four timestamps. Alternatively, the propagation delay may be calculated in the source 2 and sent to the destination 3 in another packet, such as the next timing packet. In all of these cases, the network propagation delay is supplied to the destination 3, where it is required in order to provide time-alignment of the slave clock 7 to the master clock 4.

Time-alignment depends on the actual propagation delays of the forward and return paths through the packet network 1. In situations where the propagation delays are symmetrical or equal, then such an arrangement provides acceptable time-alignment of the slave clock to the master clock. However, this known technique cannot determine whether the propagation delays are the same for the forward and return paths through the packet network and may therefore not provide correct or adequate time-alignment in many situations.

According to a first aspect of the invention, there is provided a system for determining relative time alignment of first and second time bases separated by a packet network, comprising: first and second interfaces containing the first and second time bases, respectively, for sending packets to the second and first interfaces, respectively, at least one of the first and second interfaces being arranged to send packet of different sizes; and a first comparison section in one of the interfaces for comparing the propagation delays of the packets of different sizes to determine the relative time alignment.

The first time base may be a master time base, the second time base may be a slave time base, and the second interface may include a controller for synchronising the slave time base to the master time base.

The first comparison section may be arranged to form the difference between the propagation delays. The first comparison section may be arranged to determine, from the difference, the number of network nodes equivalent to a network path from the at least one of the first and second interfaces to the other thereof. The first comparison section may be arranged to determine the number as the difference between the propagation delays divided by the difference between the delays caused by each network node for the packets of different sizes.

The at least one of the first and second interfaces may be arranged to send packets of at least three different sizes and the first comparison section may be arranged to perform pair-wise comparisons for at least two different packet size combinations.

Both of the first and second interfaces may be arranged to send packets of different sizes and the other of the interfaces may comprise a second comparison section for comparing the propagation delays of the packets of different sizes.

### SUMMARY

According to a second aspect of the invention, there is provided a method of determining relative time alignment of first and second time bases separated by a packet network, comprising sending packets of different sizes across the network from at least one of the time bases to the other thereof and comparing the propagation delays of the packets of different sizes so as to derive the relative time alignment.

Such an arrangement allows the actual propagation delays for forward and return paths through a packet network to be determined more accurately, for example when such propagation delays are asymmetrical. It is thus possible to provide more accurate time-alignment across the network.

### BRIEF DESCRIPTION OF THE DRAWINGS

FIG. 1 is a block schematic diagram of a known arrangement for determining relative time alignment across a packet network;

FIG. 2 is a block schematic diagram illustrating an example of a non-symmetric packet network with different forward and return propagation delays; and

FIG. 3 is a block schematic diagram of an arrangement for determining relative timing alignment across a packet network constituting an embodiment of the invention.

### DETAILED DESCRIPTION

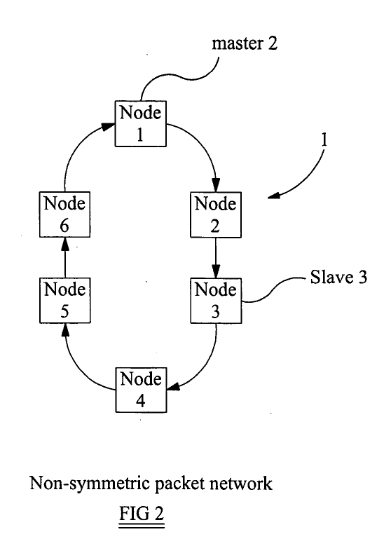

As shown in FIG. 2, a packet network may have non-symmetrical propagation delays for forward and return paths between the same pair of interfaces. For example, a packet network may be implemented using a ring-like structure such that packets always propagate in the same direction around the ring. Thus, in the illustrated example, the source or “master” supplies packets to node 1 and the destination or “slave” receives packets from node 3. In this network, there is a single node 2 through which the packets propagate in the forward path. However, in the return path from the slave to the master, the packets propagate through three nodes labelled node 4, node 5 and node 6. Thus, packets travelling along the return path experience a larger propagation delay than packets propagating along the forward path, assuming that each of the nodes creates the same propagation delay. In fact, the propagation delay through each node may vary because of the structure of the node. It has not previously been possible to assess the actual propagation delays or the relative propagation delays for the forward and return paths between interfaces. This has therefore limited the accuracy of time-alignment which can be achieved across such a network.

In general, elements within a packet network operate by receiving a packet completely before forwarding it to the next element of the network using the appropriate port. This technique is known as “store and forward”. Thus, more time is required to forward a larger packet than a smaller packet through each such element. It has been found that this may be used to determine, at least partially, the network typology between any two nodes.

The packet delay in microseconds associated with the store and forward process for a single node is shown in the following table for various packet sizes and link rates. The times in the table relate only to the data bits and do not take account of any post-space or pre-amble which may be associated with the physical layer of the network.

| | Links speed (MHz) | | |
|---|---|---|---|
| Pkt Size (bytes) | 100 | 1000 | 10000 |
| 64 | 5.120 | 0.512 | 0.051 |
| 256 | 20.480 | 2.048 | 0.205 |
| 512 | 40.960 | 4.096 | 0.410 |
| 1024 | 81.920 | 8.192 | 0.819 |
| 1518 | 121.144 | 12.114 | 1.211 |

Different network elements may operate at different speeds and, in general, each node operates at a particular data rate for that node. In general, the typology of a network is not known and the speeds at which the nodes operate is not known. However, all possible data rates which may be used in a network are known and, in any network, there is a relatively simple relationship between the possible node data rates. For example, nodes typically operate at 100 MHz, 1000 MHz and 10000 MHz. The propagation delay through, for example, a node operating at 100 MHz is 10 times the propagation delay of a node operating at 1000 MHz. Thus, a 100 MHz node is equivalent to 10 1000 MHz nodes and it has been found that use may be made of this feature.

The propagation delay or transit time Tₘₛ from the source or master 2 to the slave or destination 3 through the packet network 1 may be written as:
Tₘₛ=Tₙₙ+c

where c is a constant and is dependent on passive delays and Tₙₙ is a delay which is dependent on the packet size. It is therefore possible to determine the link speed of the node by sending two different packet sizes through the link. If the network node actually comprises a plurality of elements, then the propagation delay for an example of such a network is:
Tₘₛ=X×(Tₙₙ₁₀₀₀)+Y×(Tₙₙ₁₀₀₀)+Z×(Tₙₙ₁₀₀₀₀)+c
where X is the number of 100 MHz nodes, Y is the number of 1000 MHz nodes and Z is the number of 10000 MHz nodes. This expression may be simplified by referring the delays to the fastest nodes in the network. In particular, for the above example, the propagation delay is given by:
(X.100+Y.10+Z)Tₙₙ₁₀₀₀₀+c
this may be rewritten as:
Tₘₛ=N×Tₙₙ+c

where Tₙₙ is the transit or propagation delay through the fastest node in the network and N is the number of “equivalent” fastest nodes which would provide the same propagation delay as the actual path through the network. If the speed of the fastest node is not known, then a default value equal to the technological limit may be used, for example by assuming that the fastest node operates at 40 GHz. Thus, the fastest (or fastest possible) node speed is known but the number of such nodes or equivalent nodes and the constant delay are not known. Two measurements for packets of different sizes are therefore needed in order to allow the constant delay and the number of nodes to be determined, from which it is then possible to determine the equivalent structure of the path and the propagation delay for packets of any size.

Using the delays given in the above table for a path comprising 8 1000 MHz nodes and 2 100 MHZ nodes with a constant delay of 0.5 microseconds, the transit or propagation delays for packets of 512 and 1518 bits are as follows:
Tₘₛ512=8×4.096+2×40.960+0.5=115.188
Tₘₛ1518=8×12.114+2×121.144+0.5=339.700

As described hereinafter, measurements of the transit delays for packets of these sizes can be made and the number of equivalent 1000 MHz links and the constant delay can be found by solving the following simultaneous equations:
115.188=N×4.096+c
339.7=N×12.114+c
which gives N=28.

This measurement can be performed for both the forward and return paths between the source 2 and the destination 3 via the packet network 1 so as to determine the topologies in both directions and, in particular, determine any asymmetry between the forward and return paths. This information may then be used to adjust the alignment signal at the destination 3 so as to correct for any such imbalances.

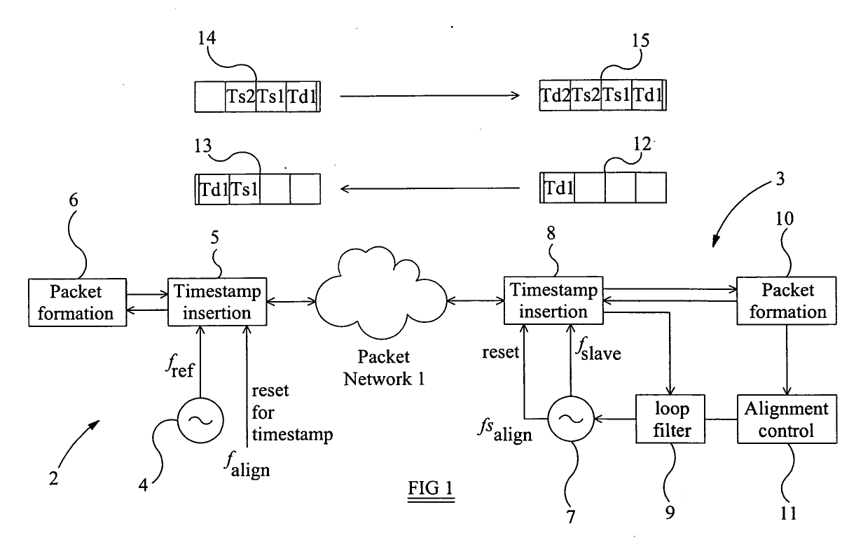

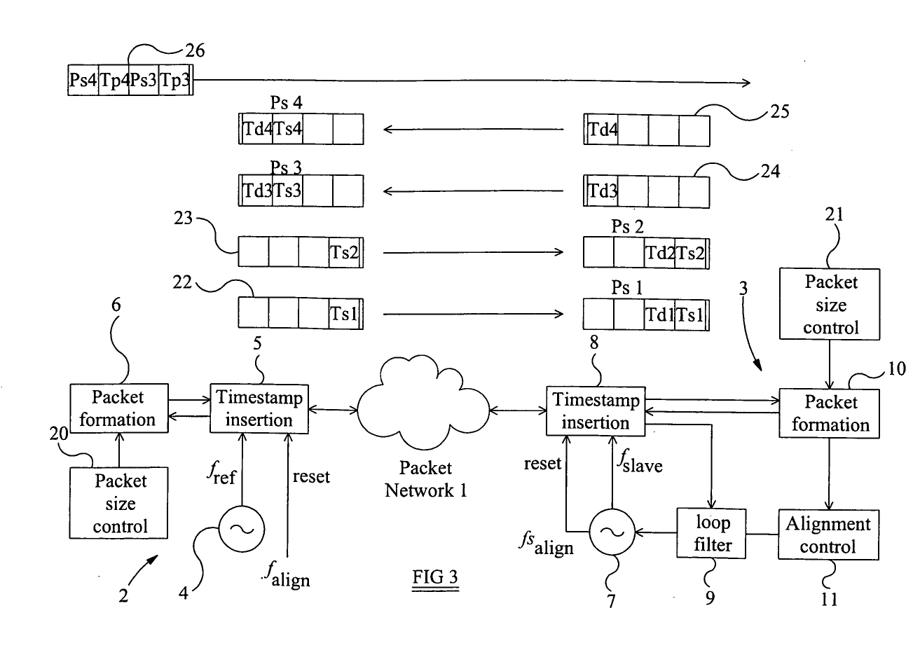

FIG. 3 illustrates an arrangement for performing this technique for the situation described hereinbefore with reference to FIG. 1. The source 2 of FIG. 3 differs from that of FIG. 1 in that the packet formation section 6 is controlled by a packet size control section 20 and the packet formation section 10 of the destination 3 is controlled by a packet size control section 21. Phase-locking of the slave clock 7 to the master clock 4 across the network is performed, for example, as described hereinbefore. Also, if desired, an initial attempt at time alignment may be performed as described hereinbefore under the assumption that the forward and return paths have the same propagation delays.

In order to improve the time-alignment, the packet size control section 20 causes the packet formation section 6 to form a packet 22 having a packet size Ps1. The packet 22 is transmitted to the network 1 and is timestamped in the section 5 with the source timestamp Ts1. On arrival at the destination 3, the packet 22 is timestamped with the destination time Td1. The timestamps and the packet size are supplied via the section 10 to the alignment control section 11 for subsequent use in improving time-alignment.

Another packet 23, which may for example be the next timing packet, is then transmitted from the source 2. The packet size control section 20 causes the section 6 to form the packet 23 with a different packet size Ps2 from the packet 22. The packet 23 is timestamped with the source time Ts2. On arrival at the destination 3, the packet is timestamped with the destination time Td2. The packet size and the timestamps are then forwarded to the alignment control section 11.

The alignment control section 11 uses the information from the packets 22 and 23 to determine the topology of the forward path through the network 1. In particular, the number of nodes or equivalent nodes in the forward path is given by the difference between the propagation times of the packets of different size divided by the difference between the propagation delays for the packets of different sizes through a single fastest node or equivalent node.

This information about the forward path is sufficient, together with the round trip propagation delay for traversing the forward then the return paths as described hereinbefore, to allow the slave clock 7 to be more accurately time-aligned to the master clock 4. However, time alignment may be improved by performing similar measurements for the return path so as to determine its topology. Thus, as shown in FIG. 3, the packet control section 21 causes the packet formation section 10 to send packets 24 and 25 of different packet sizes Ps3 and Ps4 to the source 2 with destination timestamps Td3 and Td4. On arrival at the source 2, the packets receive source timestamps Ts3 and Ts4 and the source determines the propagation delays Tp3 and Tp4 for the packets. A packet 26 is then returned to the destination 3 and the alignment control section 11 derives from this the number of nodes or equivalent nodes in the return path by dividing the difference between the measured propagation delays by the difference between the propagation delays for the packets of the two sizes through a single fastest node or equivalent node. The destination 3 thus has more complete information about the topologies of the source and return paths and this is used by the alignment control section 11 to control the slave clock 7 so that the slave alignment signal fs_{align} becomes more accurately aligned with the master alignment signal f_{align}. These measurements are repeated from time to time, for example using consecutive timing packets or groups of consecutive timing packets spaced by other timing packets, so as to maintain improved time-alignment or compensate for changes with time of the forward and reverse path topologies through the packet network 1.

The measurements in each direction may be performed with packets of more than two sizes so as to provide more accurate or more consistent information about the topologies of the forward and return paths. For example, if packets of three different sizes are sent, then two different pair-wise calculations may be performed and any differences in the results may be averaged to provide an improved assessment of the forward and return path topologies to allow improved time-alignment to be provided. Thus, the use of more than two different packet sizes may improve measurement reliability and may also be used to confirm that delay is dependent on packet size. Optimisations may also be made for common packet sizes, which might result in discrepancies in delay that are not generally present.

It is also possible to use statistical techniques in order to determine the propagation delays of the forward and return paths. Minimum transit times and averaging may be used. Also, it is not necessary for the master and slave clocks to be phase-locked in order to determine relative time-alignment because the delays for the packets are determined from relative measurements.

It is also possible to perform time-alignment without deriving the alignment signals from clock signals, or the clock signals may be derived from the alignment signals. For example, the source may supply alignment signals and the destination may provide a slave alignment signal and generate from this a clock signal for the purpose of synchronising the slave alignment signal to the master alignment signal.

Use may also be made of time to live (TTL) fields in packets with protocols permitting this feature so as to determine how many nodes have been transverse across the packet network. The field is decremented for each passage through a network router and may be used to give a guide to a number of nodes between end-points. This may in turn be used to determine the actual speeds of the link. For example, if the TTL field has been decremented by 10 and the number of nodes is estimated to be 28, then the communication path comprises two slower nodes and 8 faster nodes. This information may also be used to improve the time alignment of the slave alignment signal to the master alignment signal.

What is claimed is:

1. A system for determining relative time alignment of first and second time bases separated by a packet network, said system comprising: first and second interfaces containing said first and second time bases, respectively, for sending packets to said second and first interfaces, respectively, at least one of said first and second interfaces being arranged to send said packets of different sizes; and a first comparison section in one of said first and second interfaces for comparing propagation delays of said packets of different sizes to determine said relative time alignment.

2. A system as claimed in claim 1, in which said first time base is a master time base, said second time base is a slave time base, and said second interface includes a controller for synchronising said slave time base to said master time base.

3. A system as claimed in claim 1, in which said first comparison section is arranged to form a difference between said propagation delays.

4. A system as claimed in claim 3, in which said first comparison section is arranged to determine, from said difference, a number of network nodes equivalent to a network path from said at least one of said first and second interfaces to said other thereof.

5. A system as claimed in claim 4, in which said first comparison section is arranged to determine said number as said difference between said propagation delays divided by a difference between delays caused by each said network node for said packets of different sizes.

6. A system as claimed in claim 1, in which said at least one of said first and second interfaces is arranged to send said packets of at least three different sizes and said first comparison section is arranged to perform pair-wise comparisons for at least two different packet size combinations.

7. A system as claimed in claim 1, in which both of said first and second interfaces are arranged to send said packets of different sizes and another of said first and second interfaces comprises a second comparison section for comparing said propagation delays of said packets of different sizes.

8. A method of determining relative time alignment of first and second time bases separated by a packet network, said method comprising the steps of: sending packets of different sizes across said network from at least one of said first and second time bases to another thereof; and comparing propagation delays of said packets of different sizes so as to derive said relative time alignment.
